(19) United States
(12) Patent Application Publication
(10) Pub. No.: US 2011/0188876 A1
(43) Pub. Date: Aug. 4, 2011

(54) IMAGE FORMING DEVICE

(75) Inventor: Masaya Arakawa, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/015,884

(22) Filed: Jan. 28, 2011

Related U.S. Application Data
(60) Provisional application No. 61/300,161, filed on Feb. 1, 2010.

(51) Int. Cl. G03G 15/20

(52) U.S. Cl. 399/70

(57) ABSTRACT

An image forming device includes an image forming section that forms toner images on paper, a fixer that fixes the toner images to the paper through heating, and a controller that changes a reference value for a warm-up control of the fixer according to a connection status of plural option devices which work by being supplied with power from the image forming device.

### CROSS-REFERENCE TO RELATED APPLICATION(S)

This application is also based upon and claims the benefit of priority from US provisional application 61/300161, filed on Feb. 1, 2010; the entire contents of which are incorporated herein by reference.

### FIELD

Embodiments disclosed in this document relate to a technique of warming up a fixer.

### BACKGROUND

An image forming device warms up a fixer before printing. The image forming device includes devices connected to a plurality of option devices, and when the option devices are connected thereto, the image forming device supplies power to the option devices.

If the types or the number of the option devices are changed, the power supplied to the fixer is changed. If the power supplied to the fixer is changed, there are cases where a warm-up of the fixer is insufficient or excessive.

### DESCRIPTION OF THE DRAWINGS

FIG. 1 is an exterior view of an image forming system.

FIG. 2 is a circuit diagram of the image forming system.

FIG. 3A is a flowchart illustrating a process of setting a warm-up end temperature.

FIG. 3B is a flowchart illustrating a process of setting a warm-up end temperature.

FIG. 4 is a table illustrating a relationship between the warm-up end temperature and the option devices.

FIG. 5A is a flowchart illustrating a process of setting a warm-up time.

FIG. 5B is a flowchart illustrating a process of setting a warm-up time.

FIG. 6 is a diagram illustrating a relationship between a warm-up preparation time and the option devices.

### DETAILED DESCRIPTION

An image forming device according to an embodiment of the invention includes an image forming section that forms toner images on paper, a fixer that fixes the toner images to the paper through heating, and a controller that changes a reference value for a warm-up control of the fixer according to a connection status of plural option devices which work by being supplied with power from the image forming device.

### First Embodiment

An image forming device according to the first embodiment will be described with reference to the accompanying drawings.

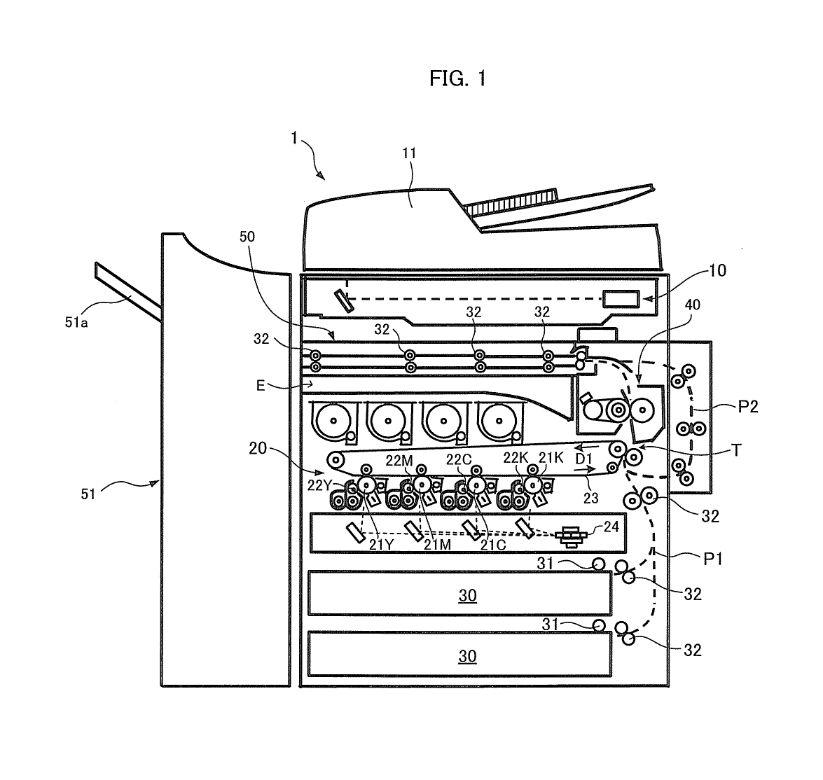

As shown in FIG. 1, an image forming device 1 includes a scanner 10 and an image forming section 20.

The scanner 10 scans and reads images on a document. An ADF (auto document feeder) 11 is positioned on the scanner 10 and carries a document to the scanner 10. The ADF 11 is attachable to or detachable from a main body of the image forming device 1. If the ADF 11 is fixed to the main body of the image forming device 1, the ADF 11 works by being supplied with power from the main body of the image forming device 1.

The image forming section 20 forms toner images on paper based on image data which is generated by reading of the scanner 10, image data which is transmitted from an external device (for example, a personal computer) to the image forming device 1, or the like.

An outline of a copying will be described as an example of processes performed by the image forming device 1.

A pickup roller 31 picks up paper in a paper feeding cassette 30, and the picked-up paper is moved along a carrying path P1. A plurality of rollers 32 are arranged along the carrying path P1, and the paper is moved through the rotation of the plurality of rollers 32.

The image forming section 20 forms electrostatic latent images on photoconductive surfaces of photoconductors 21Y, 21M, 21C and 21K, based on image data generated by reading of the scanner 10. Specifically, the surfaces of the photoconductors 21Y to 21K are charged, and the photoconductors 21Y to 21K are exposed by laser from a laser irradiator 24, thereby forming the electrostatic latent images.

The photoconductors 21Y to 21K use toner images of yellow (Y), magenta (M), cyan (C), and black (K) for being transferred to the paper.

Developing rollers (so-called MAG-rollers) 22Y, 22M, 22C and 22K supply toners to the photoconductors 21Y to 21K on which the electrostatic latent images are formed, and thus the electrostatic latent images formed on the photoconductors 21Y to 21K are developed. The photoconductors 21Y to 21K transfer the toner images formed on the photoconductive surfaces onto an intermediate transfer belt 23. The intermediate transfer belt 23 carries the toner images through the rotation in the direction of the arrow D1, and transfers the toner images on the intermediate transfer belt 23 onto the paper at a transfer position T.

The paper onto which the toner images are transferred is moved to a fixer 40, and the fixer 40 heats the paper and thus the toner images are fixed to the paper. The paper to which the toner images are fixed is moved along the carrying path P1 by the plurality of rollers 32, and then is moved to a relaying unit 50.

The relaying unit 50 is positioned under the scanner 10. The relaying unit 50 carries the paper from the fixer 40 to a finisher 51. The finisher 51 is attachable to the image forming device 1 or detachable from the image forming device 1. If the finisher 51 is installed in the image forming device 1, the finisher 51 works by being supplied with power from the image forming device 1.

The relaying unit 50 has the plurality of rollers 32, and the paper is moved by the rollers 32. There is a space E under the relaying unit 50. If the finisher 51 is not connected to the image forming device 1, paper from the fixer 40 is placed in the space E. The space E functions as a paper discharge tray.

The finisher 51 performs various kinds of processes for the paper from the relaying unit 50, and places the paper in a tray 51a. The number of trays 51a may be appropriately set. Examples of processes performed by the finisher 51 include stapling, punching, and saddle stitching.

The image forming device 1 has a carrying path P2 for reversing the paper.

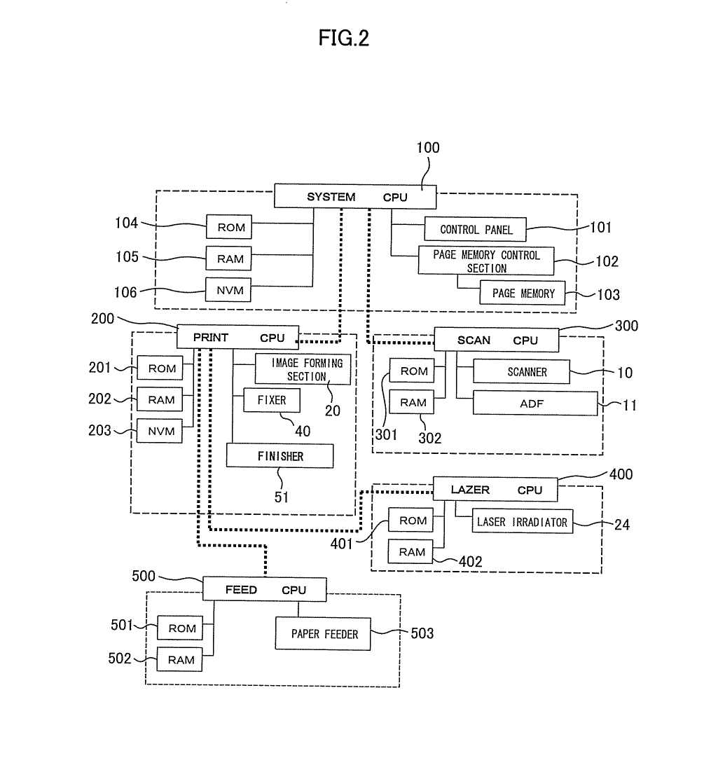

FIG. 2 is a block diagram illustrating a configuration of the image forming system. The image forming system has five CPUs.

A SYSTEM-CPU 100 communicates with a PRINT-CPU 200 in a serial manner and sends an operation instruction to the PRINT-CPU 200. The PRINT-CPU 200 performs processes regarding a printing operation in response to the operation instruction from the SYSTEM-CPU 100, and sends a status signal indicating a processed status to the SYSTEM-CPU 100.

The SYSTEM-CPU 100 communicates with a SCAN-CPU 300 in a serial manner, and sends an operation instruction to the SCAN-CPU 300. The SCAN-CPU 300 performs processes regarding image reading operation in response to the operation instruction from the SYSTEM-CPU 100, and sends a status signal indicating a processed status to the SYSTEM-CPU 100. The SCAN-CPU 300 is connected to a ROM 301 storing programs and a RAM 302 performing execution processes.

The SYSTEM-CPU 100 can ascertain operation statuses of the image forming system based on the status signals from the PRINT-CPU 200 and the SCAN-CPU 300. A control panel 101 is operated to display operation contents of the image forming system or to input predetermined information. The SYSTEM-CPU 100 controls contents displayed on the control panel 101 or receives information input via the control panel 101.

The SYSTEM-CPU 100 controls operations of a page memory control section 102. The page memory control section 102 controls data transmission with a page memory 103. The page memory control section 102 writes image data in the page memory 103. The page memory control section 102 reads image data stored in the page memory 103 according to a compression coding.

The SYSTEM-CPU 100 is connected to a ROM 104 storing programs, a RAM 105 used for execution processes, and a nonvolatile RAM (NVM) 106 storing information unique to the image forming device.

The PRINT-CPU 200 communicates with a LAZER-CPU 400 in a serial manner, and sends an operation instruction to the LAZER-CPU 400. The LAZER-CPU 400 performs processes regarding the output of the laser irradiator 24 in response to the operation instruction from the PRINT-CPU 200 and sends a status signal indicating a processed status to the PRINT-CPU 200. The PRINT-CPU 200 ascertains the processed status regarding the output of the laser irradiator 24 based on the status signal from the LAZER-CPU 400. The LAZER-CPU 400 is connected to a ROM 401 storing programs and a RAM 402 performing execution processes.

The PRINT-CPU 200 communicates with a FEED-CPU 500 in a serial manner and sends an operation instruction to the FEED-CPU 500. The FEED-CPU 500 performs processes regarding paper carrying of the paper feeder 503 in response to the operation instruction from the PRINT-CPU 200, and sends a status signal indicating a processed status to the PRINT-CPU 200. The PRINT-CPU 200 ascertains the processed status regarding the paper carrying based on the status signal from the FEED-CPU 500.

The paper feeder 503 includes paper feeders provided in the image forming device 1 in advance (including the paper feeding cassette 30 and the pickup roller 31 shown in FIG. 1) or externally installed paper feeders which are installed in the outside of the image forming device 1. If the paper feeders are installed in the image forming device 1, the paper feeders work by being supplied with power from the image forming device 1.

The PRINT-CPU 200 is connected to a ROM 201 storing programs, a RAM 202 performing execution processes, and a nonvolatile RAM (NVM) 203 storing information unique to the device. The FEED-CPU 500 is connected to a ROM 501 storing programs and a RAM 502 performing execution processes.

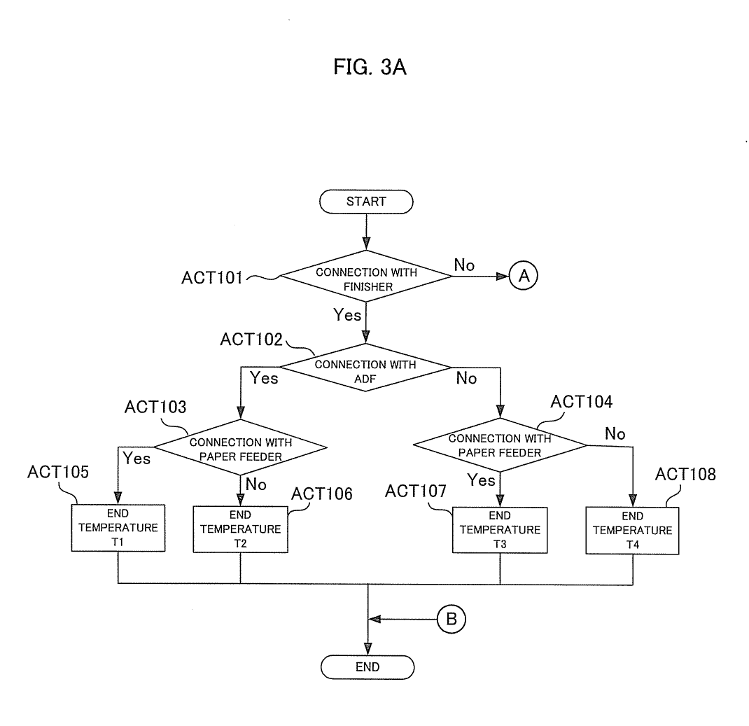

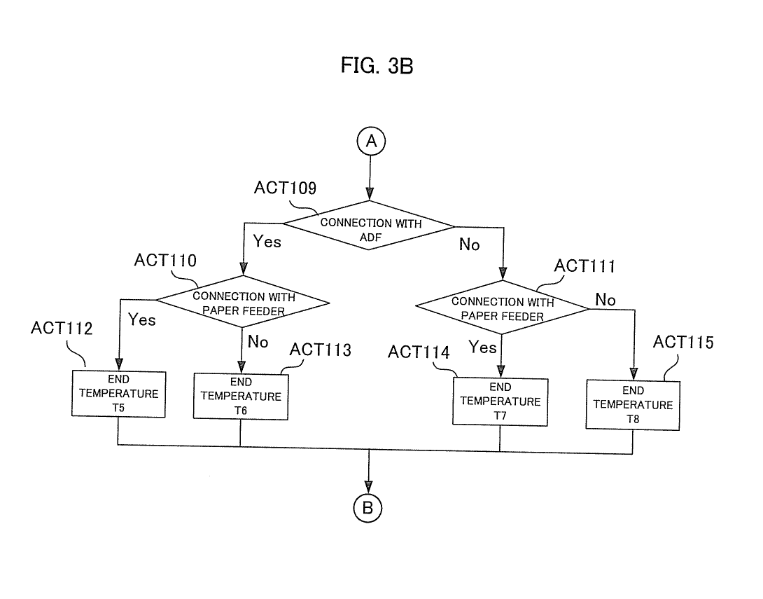

FIGS. 3A and 3B are flowcharts illustrating a process of setting an end temperature when the fixer 40 is warmed up. The process shown in FIGS. 3A and 3B is performed by the PRINT-CPU 200 when the warm-up of the fixer 40 starts. For example, the fixer 40 may start the warm-up when the image forming device 1 is powered on, or when the image forming device 1 changes modes from a sleep mode to an operation mode.

The program stored in the ROM 201 is executed by the PRINT-CPU 200 and thus the process shown in FIGS. 3A and 3B is realized.

The PRINT-CPU 200 determines whether or not the finisher 51 is connected to the image forming device 1 (ACT 101). If the finisher 51 is connected to the image forming device 1, the PRINT-CPU 200 determines whether or not the ADF 11 is connected to the image forming device 1 (ACT 102). The information for the connection of the ADF 11 is sent to the SYSTEM-CPU 100 from the SCAN-CPU 300 and then is sent to the PRINT-CPU 200 from the SYSTEM-CPU 100.

If the finisher 51 is not connected to the image forming device 1, the PRINT-CPU 200 performs an operation in ACT 109 described later.

If the ADF 11 is connected to the image forming device 1 (ACT 102, Yes), the PRINT-CPU 200 determines whether or not the externally installed paper feeder 503 is connected to the image forming device 1 (ACT 103). The information for the connection of the paper feeder 503 is sent to the PRINT-CPU 200 from the FEED-CPU 500.

If the paper feeder 503 is connected to the image forming device 1 (ACT 103, Yes), the PRINT-CPU 200 sets the warm-up end temperature to T1 (ACT 105). The end temperature means a temperature when the warm-up of the fixer 40 ends. The end temperature T1 is the highest of temperatures T1 to T8 described later, and is set in advance.

Information for the end temperatures T1 to T8 is stored in advance in the NVM 203 so as to correspond to the combination of the option devices connected to the image forming device 1. In this embodiment, the option devices include the ADF 11, the finisher 51, and the paper feeder 503. Devices which are connected to the image forming device 1 and work by being supplied with power from the image forming device 1 can be used as the option devices.

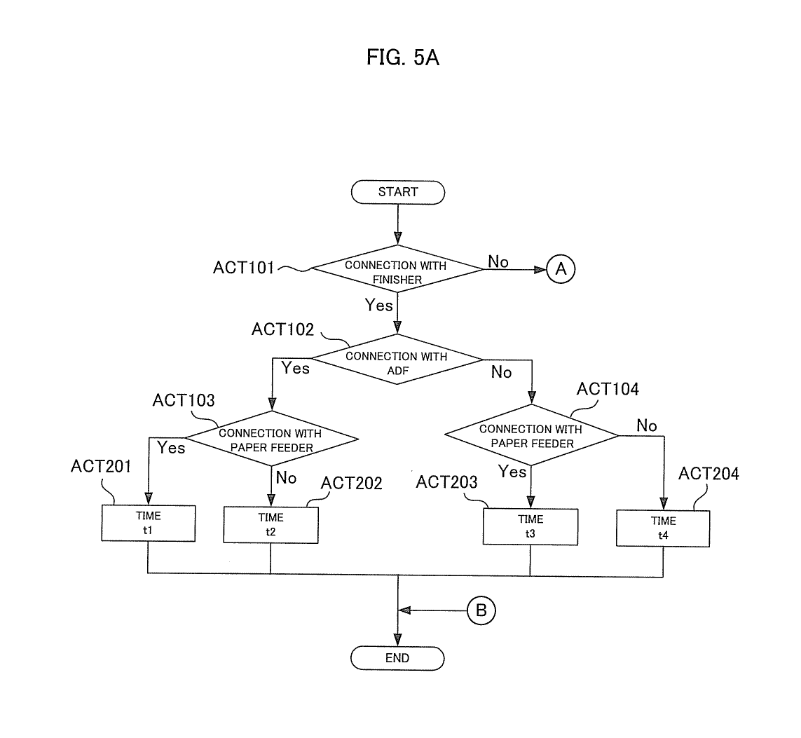

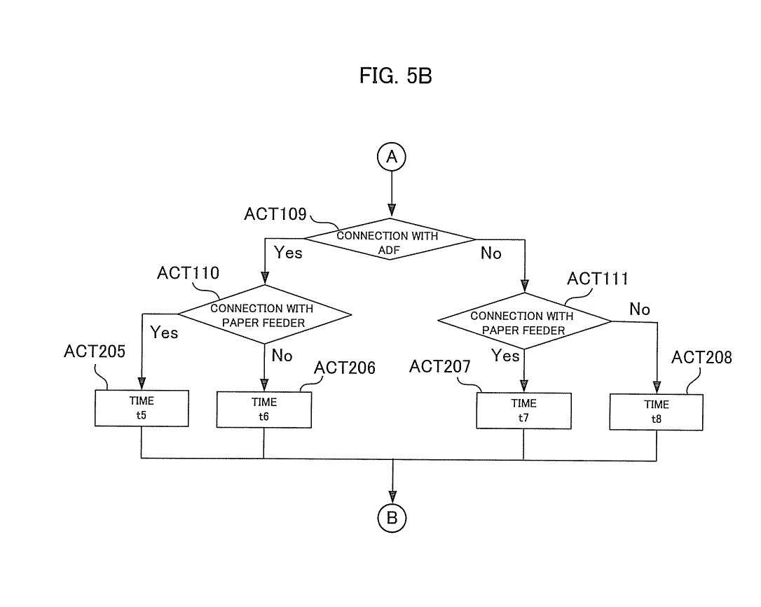

The PRINT-CPU 200 detects the option devices connected to the image forming device 1, and sets the end temperatures T1 to T8 using the detected option devices and the data shown in FIG. 5.

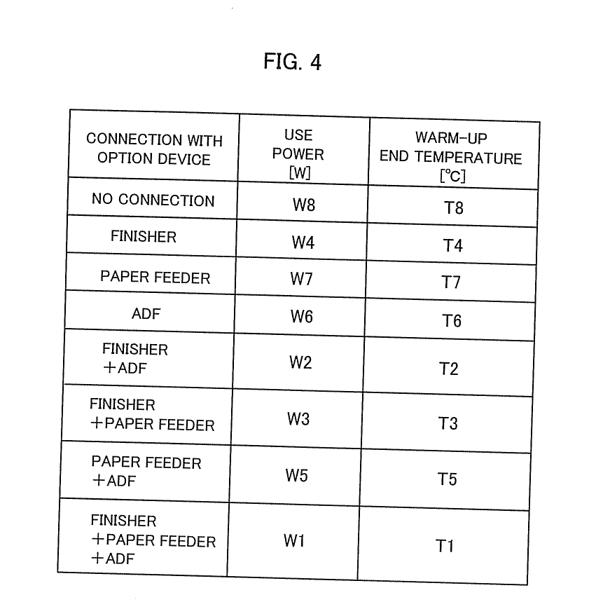

The use power shown in FIG. 4 is power for operating the fixer 40. Since the power used in the image forming system is constant, the use power in the fixer 40 is lowered as the number of option devices connected to the image forming device 1 increases. The use power in the fixer 40 is lowered as the power consumption in the option devices connected to the image forming device 1 is heightened.

In this embodiment, the end temperatures T1 to T8 are set using the data shown in FIG. 4, but the end temperatures may be set using other methods. Specifically, the PRINT-CPU 200 calculates power usable in the fixer 40 based on option devices connected to the image forming device 1.

The option devices connected to the image forming device 1 work by being supplied with power from the image forming device 1. If the connection of the option devices is detected, it is possible to calculate the power used in the option devices. If the power used in the option devices is calculated, it is possible to calculate the power usable in the fixer 40 based on the total power usable in the image forming device 1.

The PRINT-CPU 200 can set the warm-up end temperature based on the use power in the fixer 40. If data indicating a correspondence relationship between the use power in the fixer 40 and the warm-up end temperature is stored in the NVM 203 in advance, it is possible to set the warm-up end temperature based on the use power in the fixer 40. On the other hand, the warm-up end temperature may be calculated based on an operational equation having the use power in the fixer 40 as a parameter.

As the use power in the fixer 40 increases, the warm-up end temperature may be lowered. As the use power in the fixer 40 increases, a temperature of the fixer 40 can be maintained at a temperature necessary for printing even after the warm-up. Therefore, there is no problem even when the warm-up end temperature is set to a low temperature.

As the use power in the fixer 40 decreases, the warm-up end temperature can be heightened. As the use power in the fixer 40 decreases, it is difficult to maintain a temperature of the fixer 40 after the warm-up to a temperature necessary for printing. Therefore, at the time of the warm-up, a temperature of the fixer 40 is required to be set to a high temperature in advance.

If the paper feeder 503 is not connected to the image forming device 1 (ACT 103, No), the PRINT-CPU 200 sets the warm-up end temperature to T2 (ACT 106). The end temperature T2 is lower than the end temperature T1.

If the ADF 11 is not connected to the image forming device 1 (ACT 102, No), the PRINT-CPU 200 determines whether or not the paper feeder 503 is connected to the image forming device 1 (ACT 104). If the paper feeder 503 is connected to the image forming device 1 (ACT 104, Yes), the PRINT-CPU 200 sets the warm-up end temperature to T3 (ACT 107). The end temperature T3 is lower than the end temperature T1.

If the paper feeder 503 is not connected to the image forming device 1 (ACT 104, No), the PRINT-CPU 200 sets the warm-up end temperature to T4 (ACT 108). The end temperature T4 is lower than the end temperatures T1, T2, and T3.

If the finisher 51 is not connected to the image forming device 1 (ACT 101, No), the PRINT-CPU 200 determines whether or not the ADF 11 is connected to the image forming device 1 (ACT 109). If the ADF 11 is connected to the image forming device 1 (ACT 109, Yes), the PRINT-CPU 200 determines whether or not the paper feeder 503 is connected to the image forming device 1 (ACT 110).

If the paper feeder 503 is connected to the image forming device 1 (ACT 110, Yes), the PRINT-CPU 200 sets the warm-up end temperature to T5 (ACT 112). The end temperature T5 is lower than the end temperature T1.

If the paper feeder 503 is not connected to the image forming device 1 (ACT 110, No), the PRINT-CPU 200 sets the warm-up end temperature to T6 (ACT 113). The end temperature T6 is lower than the end temperatures T1 to T3 and T5.

If the ADF 11 is not connected to the image forming device 1 (ACT 109, No), the PRINT-CPU 200 determines whether or not the paper feeder 503 is connected to the image forming device 1 (ACT 111). If the paper feeder 503 is connected to the image forming device 1 (ACT 111, Yes), the PRINT-CPU 200 sets the warm-up end temperature to T7 (ACT 114). The end temperature T7 is lower than the end temperatures T1 to T3 and T5.

If the paper feeder 503 is not connected to the image forming device 1 (ACT 111, No), the PRINT-CPU 200 sets the warm-up end temperature to T8 (ACT 115). The end temperature T8 is the lowest of the end temperatures T1 to T8.

After setting the end temperatures T1 to T8, the PRINT-CPU 200 warms up the fixer 40.

In this embodiment, the warm-up end temperature can be changed depending on the connection status of the option devices. If the use power in the fixer 40 is lowered depending on the connection of the option devices, a temperature of the fixer 40 can be maintained during the printing by increasing the warm-up end temperature. If the option devices are not connected, the warm-up end temperature may be set to a low temperature since sufficient power can be supplied to the fixer 40 during the printing. Therefore, the warm-up of the fixer 40 can be efficiently performed depending on the connection status of the option devices.

In this embodiment, the end temperatures T2, T3 and T5 may be the same or different from each other. When the end temperatures T2, T3 and T5 are set, the number of the option devices connected to the image forming device 1 is the same but the combination of the option devices is different from each other. The end temperatures T2, T3 and T5 may be set based on the power consumption for each option device.

Even in the same option device, the power consumption in the option device may be different according to the functions of the option device. For example, the power consumption in the finisher 51 may be different according to the functions of the finisher 51. The functions of the finisher 51 include, for example, stapling, punching, and saddling. The power consumption in the finisher 51 having all the functions is higher than that in the finisher 51 omitting a portion of the functions. Therefore, the warm-up end temperature may be different according to the functions of the finisher 51.

### Second Embodiment

An image forming device according to the second embodiment will be described. In the first embodiment, the warm-up end temperature is set, but, in contrast, a warm-up time is set in the second embodiment.

FIGS. 5A and 5B are flowcharts illustrating a process of setting a time for the warm-up of the fixer 40.

The process of setting the warm-up time is the same as the process shown in FIGS. 3A and 3B. However, in this embodiment, the process of setting the warm-up time (ACT 201 to ACT 208) is different from the process shown in FIGS. 3A and 3B inactions.

The program stored in the ROM 201 is executed by the PRINT-CPU 200 and thus the process shown in FIGS. 5A and 5B is realized.

If the finisher 51, the ADF 11, and the paper feeder 503 are connected to the image forming device 1, the PRINT-CPU 200 sets the warm-up time to t1 (ACT 201). The warm-up time means a time for the warm-up of the fixer 40. The warm-up time t1 is the longest of the warm-up times t1 to t8.

The information for the warm-up times t1 to t8 is stored in advance in the NVM 203 corresponding to the combination of the option devices connected to the image forming device 1.

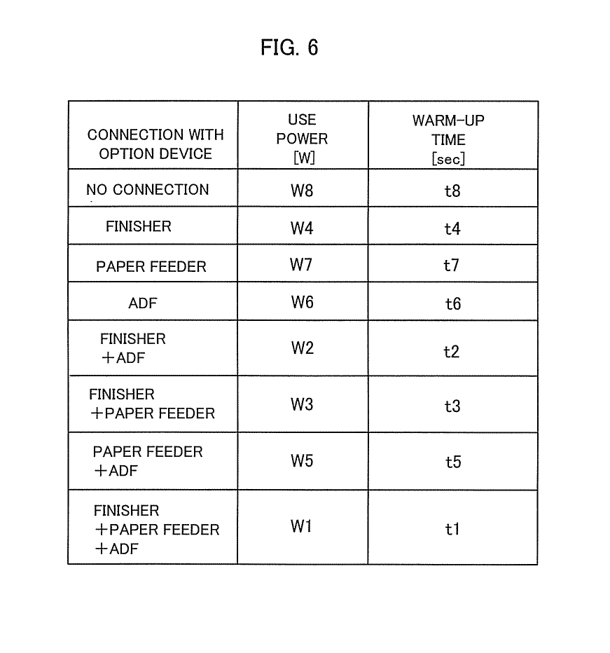

The use power shown in FIG. 6 is power for operating the fixer 40. The use power in the fixer 40 is lowered as the number of option devices connected to the image forming device 1 increases. The use power in the fixer 40 is lowered as the power consumption in the option devices connected to the image forming device 1 is heightened.

If the finisher 51 and the ADF 11 are connected to the image forming device 1, the PRINT-CPU 200 sets the warm-up time to t2 (ACT 202). The warm-up time t2 is shorter than the warm-up time t1.

If the finisher 51 and the paper feeder 503 are connected to the image forming device 1, the PRINT-CPU 200 sets the warm-up time to t3 (ACT 203). The warm-up time t3 is shorter than the warm-up time t1.

If only the finisher 51 is connected to the image forming device 1, the PRINT-CPU 200 sets the warm-up time to t4 (ACT 204). The warm-up time t4 is shorter than the warm-up times t1 to t3.

If the ADF 11 and the paper feeder 503 are connected to the image forming device 1, the PRINT-CPU 200 sets the warm-up time to t5 (ACT 205). The warm-up time t5 is shorter than the warm-up time t1.

If only the ADF 11 is connected to the image forming device 1, the PRINT-CPU 200 sets the warm-up time to t6 (ACT 206) The warm-up time t6 is shorter than the warm-up times t1 to t3 and t5.

If only the paper feeder 503 is connected to the image forming device 1, the PRINT-CPU 200 sets the warm-up time to t7 (ACT 207). The warm-up time t7 is shorter than the warm-up times t1 to t3 and t5.

If none of the finisher 51, the ADF 11, and the paper feeder 503 are connected to the image forming device 1, the PRINT-CPU 200 sets the warm-up time to t8 (ACT 208). The warm-up time t8 is the shortest of the warm-up times t1 to t8.

If the warm-up time is changed, a temperature of the fixer 40 can be changed after the completion of the warm-up. If the use power in the fixer 40 is lowered due to the connection of the option devices, the temperature of the fixer 40 can be maintained during the printing by lengthening the warm-up time. If the option devices are not connected, the warm-up time may be reduced since sufficient power can be supplied to the fixer 40 during the printing. Therefore, when the usable power in the image forming system has a limit, the warm-up of the fixer 40 can be efficiently performed depending on the connection status of the option devices.

In this embodiment, the warm-up times t2, t3 and t5 may be the same or different from each other. When the warm-up times t2, t3 and t5 are set, the number of the option devices connected to the image forming device 1 is the same but the combination of the option devices is different from each other. The warm-up times t2, t3 and t5 may be set based on the power consumption for each option device.

Even in the same option device, the power consumption in the option device may be different according to the functions of the option device. For example, the power consumption in the finisher 51 may be different according to functions of the finisher 51. The functions of the finisher 51 include, for example, stapling, punching, and saddling. The power consumption in the finisher 51 having all the functions is higher than that in the finisher 51 omitting a portion of the functions. Therefore, the warm-up time may be different according to the functions of the finisher 51.

A program for executing the actions (FIGS. 3A, 3B, 5A and 5B) described in the first and second embodiments may be downloaded to the image forming device via a network or may be stored in a computer readable recording medium. When the program is stored in a recording medium, the program in the recording medium may be installed in the image forming device.

Recording media which can store programs and can be read by a computer can be used as the recording media. The recording media include, for example, an internal storage device embedded in a computer such as ROM or RAM, a portable storage medium such as CD-ROM, a flexible disc, a DVD disc, a magneto-optical disc, or an IC card, a database storing computer programs, or, a transmission medium on other computers and databases thereof or a line. Functions obtained in advance through the installation or the download may be realized along with an OS (operating system) inside a device.

The program may be an execution module of which a portion or the entirety is generated dynamically.

Various kinds of processes which are realized by a processor executing the program may be executed in ASIC in a circuital manner.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming device comprising:
an image forming section that forms toner images on paper;
a fixer that fixes the toner images to the paper through heating; and
a controller that changes a reference value for a warm-up control of the fixer according to a connection status of plural option devices which work by being supplied with power from the image forming device.

2. The device according to claim 1, wherein the controller calculates power which can be supplied to the fixer based on the option devices connected to the image forming device and changes the reference value according to the calculated power.

3. The device according to claim 2, wherein the controller sets the reference value using data indicating a correspondence relationship between power which can be supplied to the fixer and the reference value.

4. The device according to claim 3, further comprising a memory storing the data.

5. The device-according to claim 1, wherein the controller accumulates heat in the fixer by rotating and overheating the fixer during the warm-up control.

6. The device according to claim 1, wherein the reference value is a setting temperature of the fixer after the warm-up is performed.

7. The device according to claim 6, wherein the controller lowers the setting temperature as the number of the option devices connected to the image forming device becomes smaller.

8. The device according to claim 6, wherein the controller lowers the setting temperature as total power consumption in the option devices connected to the image forming device becomes smaller.

9. The device according to claim 1, wherein the reference value is a warm-up time for the fixer.

10. The device according to claim 9, wherein the controller shortens the warm-up time as the number of the option devices connected to the image forming device becomes smaller.

11. The device according to claim 9, wherein the controller shortens the warm-up time as total power consumption in the option devices connected to the image forming device becomes smaller.

12. The device according to claim 1, wherein the option devices include at least one of a paper feeder which supplies paper to the image forming section, a finisher which performs a subsequent process for paper from the fixer, and a document feeding device which carries paper to a scanner provided in the image forming device.

13. The device according to claim 1, wherein the option devices include a plurality of finishers which perform a subsequent process for paper from the fixer and have amounts of power consumption different from each other.

14. A warm-up method of a fixer comprising:
detecting option devices connected to an image forming device having the fixer; and
changing a reference value for a warm-up control of the fixer according to a connection status of the option devices.

15. The method according to claim 14, wherein power which can be supplied to the fixer is calculated based on the option devices connected to the image forming device and the reference value is changed according to the calculated power.

16. The method according to claim 15, wherein the reference value is set using data indicating a correspondence relationship between power which can be supplied to the fixer and the reference value.

17. The method according to claim 14, wherein the reference value is a setting temperature of the fixer after the warm-up is performed, and
wherein the setting temperature is lowered as the number of the option devices connected to the image forming device becomes smaller.

18. The method according to claim 14, wherein the reference value is a setting temperature of the fixer after the warm-up is performed, and
wherein the setting temperature is lowered as total power consumption in the option devices connected to the image forming device becomes smaller.

19. The method according to claim 14, wherein the reference value is a warm-up time for the fixer, and
wherein the warm-up time is shortened as the number of the option devices connected to the image forming device becomes smaller.

20. The method according to claim 14, wherein the reference value is a warm-up time for the fixer, and
wherein the warm-up time is shortened as total power consumption in the option devices connected to the image forming device becomes smaller.
